(19) United States
(12) Patent Application Publication
(10) Pub. No.: US 2010/0240311 A1
(43) Pub. Date: Sep. 23, 2010

(54) WIRELESS COMMUNICATIONS IN MULTI-CARRIER SYSTEMS

(75) Inventors: Danlu Zhang, San Diego, CA (US); Sharad Deepak Sambhwani, San Diego, CA (US); Aziz Gholmieh, Del Mar, CA (US)

Correspondence Address: QUALCOMM INCORPORATED, 5775 MOREHOUSE DR., SAN DIEGO, CA, 92121, US

(73) Assignee: QUALCOMM, Incorporated, San Diego, CA (US)

(21) Appl. No.: 12/719,780

(22) Filed: Mar. 8, 2010

Related U.S. Application Data
(60) Provisional application No. 61/160,816, filed on Mar. 17, 2009.

(51) Int. Cl. H04B 17/00

(52) U.S. Cl. 455/62

(57) ABSTRACT

Systems and methods for communicating over multiple carriers are described herein. Information is communicated in a wireless system over an anchor carrier. An access terminal is provided to communicate over the anchor carrier in a non-compressed mode and concurrently and in parallel search for additional communication devices over another carrier. Further, the access terminal maintains an active set of communication devices to communicate with over the anchor carrier and the other carrier.

### CLAIM OF PRIORITY UNDER 35 U.S.C. §119

The present application for patent claims priority to Provisional Application No. 61/160,816 entitled “MOBILITY IN MULTI-BAND HIGH SPEED PACKET ACCESS (HSPA)” filed Mar. 17, 2009, which is assigned to the assignee hereof and is hereby expressly incorporated by reference herein.

### BACKGROUND

1. Field

The present application relates generally to communications, and more specifically to systems and method to communicate over multiple carriers.

2. Background

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance. To support the enhanced performance new systems and methods for efficiently communicating over multiple carriers are needed.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include efficient communication over multiple carriers.

One embodiment of the disclosure provides a wireless communication apparatus operative in a communication network. The apparatus comprises a transceiver configured to communicate information over a first carrier frequency. The apparatus further comprises a processing circuit configured to search a second carrier frequency and to evaluate a quality estimate of the second carrier frequency. The transceiver is further configured to communicate over the second carrier frequency based upon the quality estimate. The processing circuit is further configured to search the second carrier frequency concurrently and in parallel with the transceiver communicating over the first carrier frequency.

Another embodiment of the disclosure provides a wireless communication apparatus operative in a communication network. The apparatus comprises a transceiver configured to communicate information over at least one of a first carrier frequency and a second carrier frequency. The apparatus further comprises a memory configured to maintain an active set comprising at least a first communication device and a second communication device. The wireless communication apparatus is configured to communicate with the first communication device over the first carrier frequency. The wireless communication apparatus is configured to communicate with the second communication device over the second carrier frequency. The active set is a set of communication devices that serve the wireless communication apparatus. The apparatus further comprises a processing circuit configured to search at least one of a first carrier frequency and a second carrier frequency for at least one additional communication device and to evaluate a quality estimate of a communication link with the additional communication device. The processing circuit is further configured to add the additional communication device to the active set based upon the quality estimate. The processing circuit is further configured to search the at least one of the first carrier frequency and the second carrier frequency concurrently and in parallel with the transceiver communicating over the at least one of the first carrier frequency and the second carrier frequency.

Yet another embodiment of the disclosure provides a method for communicating in a communication network. The method comprises searching a second carrier frequency concurrently and in parallel with communicating information over a first carrier frequency. The method further comprises evaluating a quality estimate of the second carrier frequency. The method further comprises communicating over the second carrier frequency based upon the quality estimate.

A further embodiment of the disclosure provides a method for communicating in a communication network. The method comprises communicating information over at least one of a first carrier frequency and a second carrier frequency. The method further comprises maintaining an active set comprising at least a first communication device and a second communication device. The active set is a set of communication devices that serve a wireless communication apparatus over the first carrier frequency and the second carrier frequency. The first communication device serves the wireless communication device over the first carrier frequency. The second communication device serves the wireless communication device over the second carrier frequency. The method further comprises searching at least one of a first carrier frequency and a second carrier frequency for at least one additional communication device concurrently and in parallel with the transceiver communicating over the at least one of the first carrier frequency and the second carrier frequency. The method further comprises evaluating a quality estimate of a communication link with the additional communication device. The method further comprises adding the additional communication device to the active set based upon the quality estimate.

Yet a further embodiment of the disclosure provides a wireless communication apparatus operative in a communication network. The apparatus comprises means for communicating information over a first carrier frequency. The apparatus further comprises means for searching a second carrier frequency and to evaluate a quality estimate of the second carrier frequency. The communicating means is further configured to communicate over the second carrier frequency based upon the quality estimate. The searching means is further configured to search the second carrier frequency concurrently and in parallel with the communicating means communicating over the first carrier frequency.

Another embodiment of the disclosure provides a wireless communication apparatus operative in a communication network. The apparatus comprises means for communicating information over at least one of a first carrier frequency and a second carrier frequency. The apparatus further comprises means for maintaining an active set comprising at least a first communication device and a second communication device. The wireless communication apparatus is configured to communicate with the first communication device over the first carrier frequency. The wireless communication apparatus is configured to communicate with the second communication device over the second carrier frequency. The active set is a set of communication devices that serve the wireless communication apparatus. The apparatus further comprises means for searching at least one of a first carrier frequency and a second carrier frequency for at least one additional communication device and to evaluate a quality estimate of a communication link with the additional communication device. The searching means is further configured to add the additional communication device to the active set based upon the quality estimate. The searching means is further configured to search the at least one of the first carrier frequency and the second carrier frequency concurrently and in parallel with the communicating means communicating over the at least one of the first carrier frequency and the second carrier frequency.

Yet another embodiment of the disclosure provides a computer program product, comprising computer-readable medium. The computer-readable medium comprises code for causing a computer to search a second carrier frequency concurrently and in parallel with communicating information over a first carrier frequency. The computer-readable medium further comprises code for causing a computer to evaluate a quality estimate of the second carrier frequency. The computer-readable medium further comprises code for causing a computer to communicate over the second carrier frequency based upon the quality estimate.

A further embodiment of the disclosure provides a computer program product, comprising computer-readable medium. The computer-readable medium comprises code for causing a computer to communicate information over at least one of a first carrier frequency and a second carrier frequency. The computer-readable medium further comprises code for causing a computer to maintain an active set comprising at least a first communication device and a second communication device. The active set is a set of communication devices that serve a wireless communication apparatus over the first carrier frequency and the second carrier frequency. The first communication device serves the wireless communication device over the first carrier frequency. The second communication device serves the wireless communication device over the second carrier frequency. The computer-readable medium further comprises code for causing a computer to search at least one of a first carrier frequency and a second carrier frequency for at least one additional communication device concurrently and in parallel with the transceiver communicating over the at least one of the first carrier frequency and the second carrier frequency. The computer-readable medium further comprises code for causing a computer to evaluate a quality estimate of a communication link with the additional communication device. The computer-readable medium further comprises code for causing a computer to add the additional communication device to the active set based upon the quality estimate

### BRIEF DESCRIPTION OF THE DRAWINGS

FIG. 1 illustrates an exemplary wireless communication network.

FIG. 2 illustrates functional block diagrams of an exemplary access node and an exemplary access terminal shown in FIG. 1.

FIG. 3 is a functional block diagram of a second exemplary access terminal of FIG. 1.

FIG. 4 is a functional block diagram of a second exemplary access node of FIG. 1

FIG. 5 is a flowchart of an exemplary process of searching for access nodes on multiple carriers.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

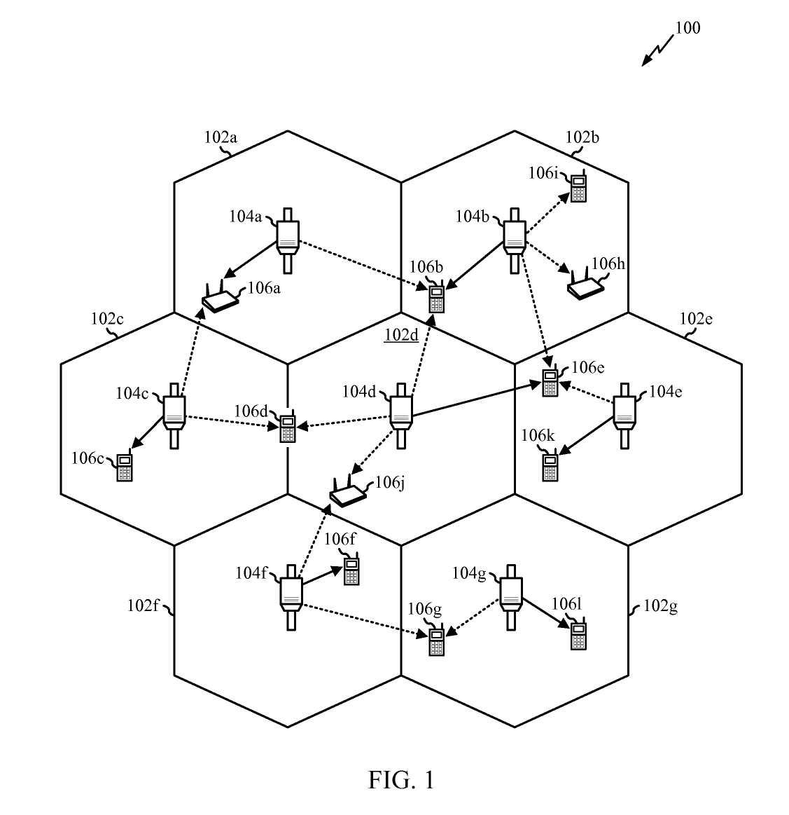

FIG. 1 illustrates an exemplary wireless communication network 100. The wireless communication network 100 is configured to support communication between a number of users. The wireless communication network 100 may be divided into one or more cells 102, such as, for example, cells 102a-102g. Communication coverage in cells 102a-102g may be provided by one or more nodes 104 (e.g., base stations), such as, for example, nodes 104a-104g. Each node 104 may provide communication coverage to a corresponding cell 102. The nodes 104 may interact with a plurality of access terminals (ATs), such as, for example, ATs 106a-1061.

Each AT 106 may communicate with one or more nodes 104 on a forward link (FL) and/or a reverse link (RL) at a given moment. A FL is a communication link from a node to an AT. A RL is a communication link from an AT to a node. The FL may also be referred to as the downlink. Further, the RL may also be referred to as the uplink. The nodes 104 may be interconnected, for example, by appropriate wired or wireless interfaces and may be able to communicate with each other. Accordingly, each AT 106 may communicate with another AT 106 through one or more nodes 104. For example, the AT 106j may communicate with the AT 106h as follows. The AT 106j may communicate with the node 104d. The node 104d may then communicate with the node 104b. The node 104b may then communicate with the AT 106h. Accordingly, a communication is established between the AT 106j and the AT 106h.

The wireless communication network 100 may provide service over a large geographic region. For example, the cells 102a-102g may cover only a few blocks within a neighborhood or several square miles in a rural environment. In one embodiment, each cell may be further divided into one or more sectors (not shown).

As described above, a node 104 may provide an access terminal (AT) 106 access within its coverage area to a communications network, such as, for example the internet or a cellular network.

An AT 106 may be a wireless communication device (e.g., a mobile phone, router, personal computer, server, etc.) used by a user to send and receive voice or data over a communications network. An access terminal (AT) may also be referred to herein as a user equipment (UE), as a mobile station (MS), or as a terminal device. As shown, ATs 106a, 106h, and 106j comprise routers. ATs 106b-106g, 106i, 106k, and 106l comprise mobile phones. However, each of ATs 106a-106l may comprise any suitable communication device.

A wireless multiple-access communication system may simultaneously support communication for multiple wireless access terminals. As mentioned above, each access terminal may communicate with one or more nodes via transmissions on the forward and reverse links. The forward link (or downlink) refers to the communication link from the node to the access terminal, and the reverse link (or uplink) refers to the communication link from the access terminal to the node. This communication link may be established via a single-in-single-out system, a multiple-in-multiple-out (“MIMO”) system, or some other type of system.

A MIMO system employs multiple (NT) transmit antennas and multiple (NR) receive antennas for data transmission. A MIMO channel formed by the NT transmit and NR receive antennas may comprise NS independent channels, which are also referred to as spatial channels, where NS≦min {NT, NR}. Each of the NS independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables a device (e.g., a node, an access terminal, etc.) to extract a transmit beam-forming gain on the forward link when multiple antennas are available at the device.

The teachings herein may be incorporated into a device (e.g., a node, an access terminal, etc.) employing various components for communicating with at least one other device.

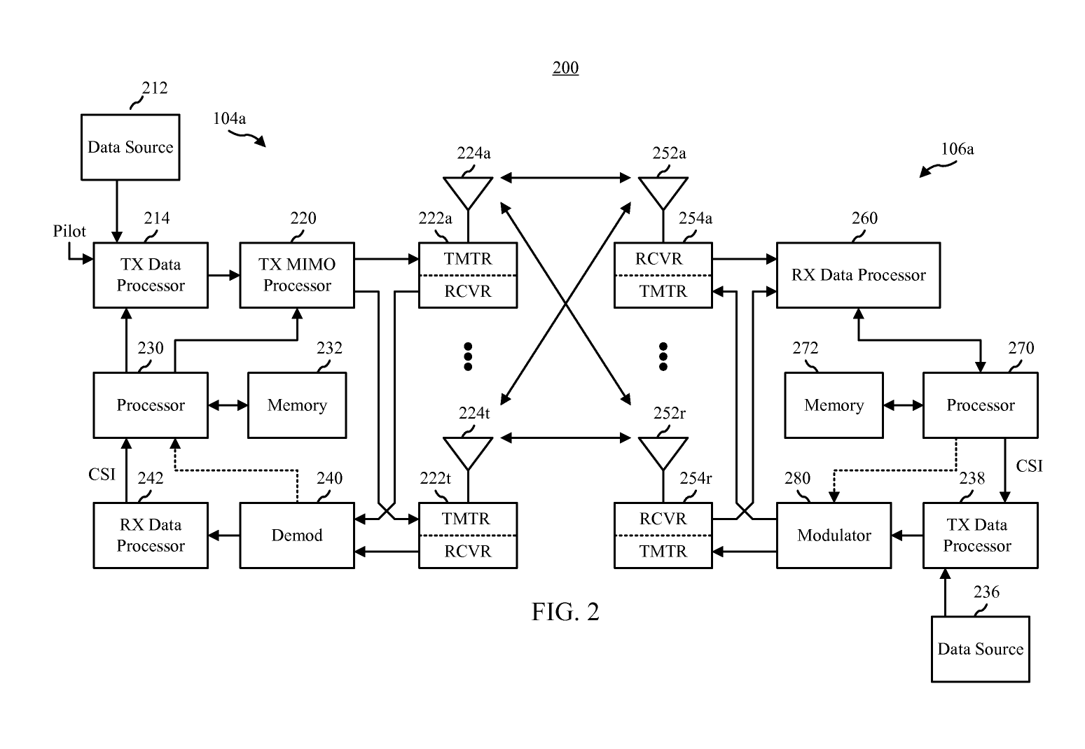

FIG. 2 illustrates functional block diagrams of an exemplary node 104a and an exemplary access terminal 106a shown in FIG. 1. In a MIMO system 200, the node 104a communicates with one or more ATs such as the AT 106a. At the node 104a, traffic data for a number of data streams is provided from a data source 212 to a transmit (“TX”) data processor 214.

In one embodiment, each data stream is transmitted over a respective transmit antenna. The TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 230. A data memory 232 may store program code, data, and other information used by the processor 230 or other components of the node 104a.

The modulation symbols for all data streams are then provided to a TX MIMO processor 220, which may further process the modulation symbols (e.g., for OFDM). The TX MIMO processor 220 then provides NT modulation symbol streams to NT transceivers (“XCVR”) 222A through 222T. In some aspects, the TX MIMO processor 220 applies beam-forming weights to the symbols of the data streams and to the antenna from which the symbol is being transmitted.

Each transceiver 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 222A through 222T are then transmitted from NT antennas 224A through 224T, respectively.

At the AT 106a, the transmitted modulated signals are received by NR antennas 252A through 252R and the received signal from each antenna 252 is provided to a respective transceiver (“XCVR”) 254A through 254R. Each transceiver 254 conditions (e.g., filters, amplifies, and downconverts) a respective received signal, digitizes the conditioned signal to provide samples, and further processes the samples to provide a corresponding “received” symbol stream.

A receive (“RX”) data processor 260 then receives and processes the NR received symbol streams from NR transceivers 254 based on a particular receiver processing technique to provide NT “detected” symbol streams. The RX data processor 260 then demodulates, deinterleaves, and decodes each detected symbol stream to recover the traffic data for the data stream. The processing performed by the RX data processor 260 is complementary to that performed by the TX MIMO processor 220 and the TX data processor 214 at the node 104a.

A processor 270 periodically determines which pre-coding matrix to use (discussed below). The processor 270 formulates a reverse link message comprising a matrix index portion and a rank value portion. A data memory 272 may store program code, data, and other information used by the processor 270 or other components of the AT 106a.

The reverse link message may comprise various types of information regarding the communication link and/or the received data stream. The reverse link message is then processed by a TX data processor 238. The TX data processor 238 also receives traffic data for a number of data streams from a data source 236. The modulator 280 modulates the data streams. Further, the transceivers 254A through 254R condition the data streams and transmit the data streams back to the node 104a.

At the node 104a, the modulated signals from the AT 106a are received by the antennas 224. Further, the transceivers 222 condition the modulated signals. A demodulator (“DEMOD”) 240 demodulates the modulated signals. A RX data processor 242 processes the demodulated signals and extracts the reverse link message (e.g., information) transmitted by the AT 106a. The processor 230 then determines which pre-coding matrix to use for determining the beam-forming weights. Further, the processor 230 processes the extracted message. It should be appreciated that for each node 104a and AT 106a the functionality of two or more of the described components may be provided by a single component.

As discussed above with respect to FIG. 1, the AT 106a may communicate with each of the nodes 104a-104g when in communication range of each of the nodes 104a-104g. The AT 106a may be configured to determine which node 104a-104g provides the “best” signal where the AT 106a is located and accordingly communicate with that node 104a-104g. For example, the AT 106a may receive pilot signals that are transmitted from one or more of the nodes 104a-104g. The AT 106a may calculate the signal-to-noise ratio (SNR) of the pilot signals. The pilot signal with the highest SNR may be the “best” signal. It should be noted that other quality estimates for determining the “best” signal may be used such as signal-to-noise-plus-interference ratio (SNIR), carrier-to-interference ratio (C/I), etc. However, for illustrative purposes only, SNR is used in the description herein. Accordingly, the AT 106a may communicate with the node 104a-104g that transmitted the pilot signal with the highest SNR.

As the AT 106a moves between sectors 102a-102g, the AT 106a may be configured to handoff between nodes 104a-104g. For example, the AT 106a may be in sector 102a and communicate with node 104a. The AT 106a may then move to the sector 102b. In the sector 102b, the pilot signal of the node 104b may have a higher SNR than the pilot signal of the node 104a as received by the AT 106a. Accordingly, the AT 106a may handoff to the node 104b from the node 104a and begin communicating with the node 104b instead of the node 104a.

The AT 106a may maintain a list or set of nodes 104 (corresponding to cells 102) referred to as an active set to which the AT 106a is configured to handoff. The nodes 104 of the active set may communicate with the AT 106a over one carrier on the uplink and multiple carriers on the downlink. In one embodiment, the AT 106a may communicate data to the nodes 104 of the active set over the uplink. Further, in one embodiment, the nodes 104 of the active set may transmit power control bits to control the uplink power over only one downlink carrier.

The AT 106a may maintain the list by searching for nodes 104 within communication range of the AT 106a. For example, when the AT 106a receives a pilot signal from one or more nodes 104a-104g, the AT 106a may measure the SNR of the received pilot signal. If the SNR of the received pilot signal is greater than the SNR of the nodes 104 of the active set, the node 104 with the lowest SNR is removed from the active set and the node from which the pilot signal is received is added to the active set.

As discussed above, the AT 106a may transmit information, signals, data, instructions, commands, bits, symbols, and the like (referred to collectively herein as “data”) to the node 104a via an uplink. Further, the node 104a may transmit data to the AT 106a via a downlink. Each of the uplink and the downlink may comprise one or more carriers. A carrier comprises a frequency range (e.g., 850 MHz±7 MHz). A carrier of the uplink may be referred to as an uplink carrier. A carrier of the downlink may be referred to as a downlink carrier. Accordingly the AT 106a may transmit to the node 104a over one or more uplink carriers, each carrier comprising a different frequency range. Further, the node 104a may transmit data to the AT 106a over one or more downlink carriers, each carrier comprising a different frequency range. In one embodiment, the uplink carriers comprise different frequencies than the downlink carriers. In another embodiment, the uplink and downlink carriers comprise the same frequencies.

In one embodiment, the AT 106a may be configured to communicate with the node 104a over one frequency carrier at a time. The frequency carrier over which the AT 106a communicates with the node 104a may be referred to as the anchor carrier. In order for the AT 106a to communicate with the node 104a or any other node over a carrier other than the anchor carrier, the AT 106a may change the anchor carrier to the desired carrier frequency.

The node 104a and/or other nodes 104 may be configured to communicate over multiple carriers. For example, in multi-carrier High Speed Packet Access (HSPA) (e.g., multi-band HSPA), the multiple carriers can be from multiple different frequency bands. Accordingly, the node 104a and/or other nodes 104 may transmit a pilot signal for each carrier over which it communicates. One frequency carrier used by the node 104a and/or other nodes 104 may provide different coverage than another frequency carrier. For example, a lower frequency carrier may provide a larger coverage area than a higher frequency carrier. Accordingly, the pilot signal received at the AT 106a from the node 104a over a first frequency carrier may be received with a different SNR than the pilot signal received at the AT 106a from the node 104a over a second frequency carrier. Therefore it may be beneficial to search for nodes on multiple carriers.

In one embodiment, the AT 106a may search for nodes using a non-compressed mode. In a compressed mode, the AT 106a uses gaps in communications to search for nodes. For example, the AT 106a may actively communicate with the node 104a. When there is a gap in the communication (e.g., AT 106a is not actively communicating with the node 104a), the AT 106a may search for other nodes. Accordingly, the search time of the AT 106a for other nodes is limited and some nodes may not be discovered. In a non-compressed mode, the AT 106a may continuously search on other carriers without requiring gaps in communications with the node 104a. In another embodiment, it may be beneficial for the AT 106a to switch the anchor carrier to the carrier over which a pilot signal with the best SNR is detected during a search.

In Release (Rel.) 8 Dual Cell (DC) High Speed Downlink Packet Access (HSDPA), the active set may only contain the nodes on the serving High Speed Downlink Shared Channel (HS-DSCH) cell frequency (e.g., the anchor carrier). In one embodiment described herein, however, the AT 106a may maintain one active set for all carrier frequencies. Thus, the nodes 104 chosen for the active set are chosen based on a pilot signal received over any frequency carrier. The AT 106a may further maintain the appropriate frequency carrier of the nodes 104 in the active set in order to facilitate changing the anchor carrier to the appropriate anchor carrier during handoff to a node 104.

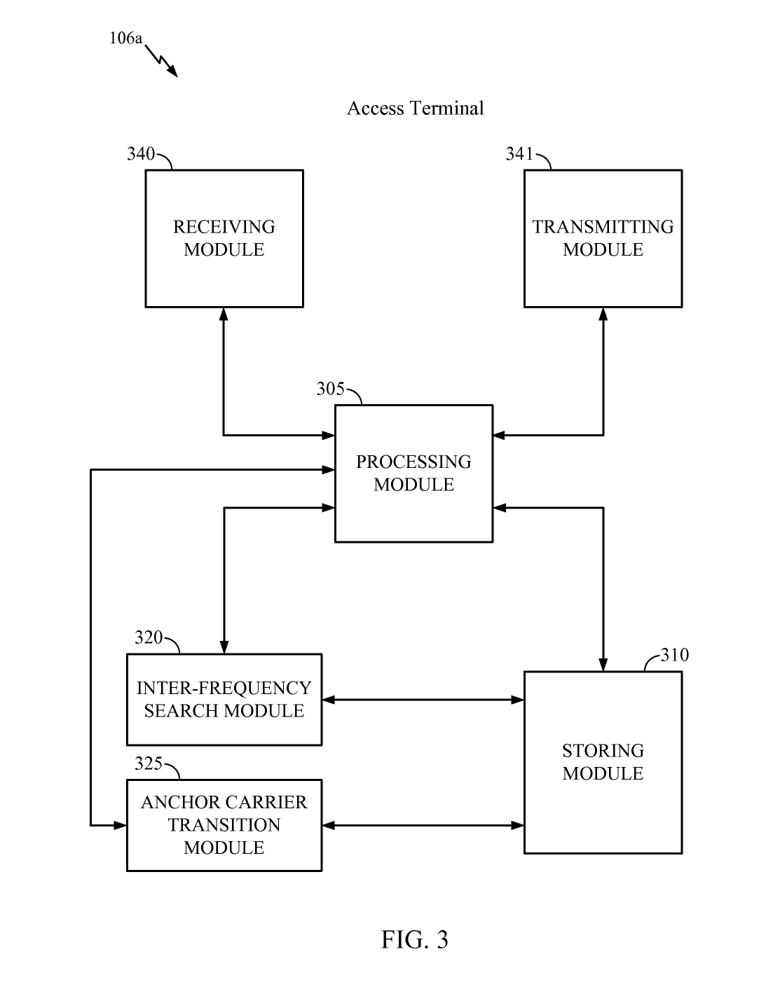

FIG. 3 is a functional block diagram of a second exemplary access terminal 106a of FIG. 1. As discussed above, the AT 106a may be a mobile phone. The AT 106a may be used to communicate information to and/or from the node 104a over an anchor carrier. The AT 106a may comprise a processing module 305 configured to process information for storage, transmission, and/or for the control of other components of the AT 106a. The processing module 305 may further be coupled to a storing module 310. The processing module 305 may read information from or write information to the storing module 310. The storing module 310 may be configured to store information before, during or after processing. In particular, the storing module 310 may be configured to store an active set. The processing module 305 may also be coupled to a receiving module 340 and a transmitting module 341. The receiving module 340 may be configured to receive an inbound wireless message from the AN 104a over the anchor carrier. The transmitting module 341 may be configured to transmit an outbound wireless message to the AN 104a over the anchor carrier. The inbound wireless message may be passed to the processing module 305 for processing. The processing module 305 may process the outbound wireless message passing the outbound wireless message to transmitting module 341 for transmission.

The processing module 305 may also be coupled to an inter-frequency search module 320. The inter-frequency search module 320 may be configured to search for nodes 104 in a non-compressed mode. For example, the AT 106a may communicate with the AN 104a via the receiving module 340 and the transmitting module 341 over the anchor carrier. The inter-frequency search module 320 may be configured to receive pilot signals over the anchor carrier and/or other carriers at substantially the same time. The inter-frequency search module 320 may continuously search for pilot signal over one or more carriers. In another embodiment, the inter-frequency search module 320 may periodically switch the carrier over which it searches for pilot signals. After detecting a pilot signal, the inter-frequency search module 320 may pass the pilot signal to the processing module 305. The processing module 305 may further be configured to determine whether the SNR of the detected pilot signal is greater than the SNR of the nodes in the current active set stored in the storing module 310. The processing module 305 may update the active set if the processing module 305 determines the SNR of the detected pilot signal is greater than the SNR of at least one of the nodes in the current active set.

In another embodiment, after the inter-frequency search module 320 detects a pilot signal and passes it to the processing module 305, the processing module 305 may generate a reporting message comprising the pilot signal and the SNR of the pilot signal. The processing module 305 may pass the reporting message to the transmitting module 341 for transmission to the node 104a with which the AT 106a is currently communicating.

The processing module 305 may also be coupled to an anchor carrier transition module 325. The anchor carrier transition module 325 may be configured to change the anchor carrier over which the receiving module 340 receives data and the transmitting module 341 transmits data. For example, the anchor carrier transition module 325 may be configured to change the anchor carrier when inter-frequency search module 320 detects a pilot signal from a node 104 with a higher SNR on a different carrier than the SNR of the pilot signal from the node 104a that the AT 106a is currently communicating with over the anchor carrier. Further, the anchor carrier transition module 325 may be configured to change the anchor carrier when handing off to a node 104 in the active set that uses a different carrier than the anchor carrier.

The receiving module 340 may further be configured to receive from the AN 104a an inbound wireless message configured to direct the receiving module 340 and/or the transmitting module 341 to handoff to and begin communication with another node 104. For example, the message may comprise an identifier of the node and the carrier frequency of the node. The receiving module 340 may pass the received message to the processing module 305. The processing module 305 may process the message and direct the receiving module 340 and/or the transmitting module 341 to communicate with the identified node 104. Further, the processing module 305 may direct the anchor carrier transition module to change the anchor carrier to the carrier identified in the received message.

The receiving module 340 and the transmitting module 341 may comprise an antenna and a transceiver. The transceiver may be configured to modulate/demodulate the outbound/inbound wireless messages going to or coming from AN 104a. The outbound/inbound wireless messages may be transmitted/received via the antenna. The antenna may be configured to communicate with the AN 104a over one or more carriers and one or more channels. The outbound/inbound wireless message may comprise voice and/or data-only information. The receiving module 340 may demodulate the data received. The receiving module 340 may modulate data to be sent from the AT 106a via to the AN 104a. The processing module 305 may provide data to be transmitted.

The storing module 310 may comprise processing module cache, including a multi-level hierarchical cache in which different levels have different capacities and access speeds. The storing module 310 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, and Zip drives

Although described separately, it is to be appreciated that functional blocks described with respect to the AT 106a need not be separate structural elements. For example, the processing module 305 and the storing module 310 may be embodied in a single chip. The processing module 305 may additionally, or in the alternative, contain memory, such as registers. Similarly, one or more of the functional blocks or portions of the functionality of various blocks may be embodied in a single chip. Alternatively, the functionality of a particular block may be implemented on two or more chips.

One or more of the functional blocks and/or one or more combinations of the functional blocks described with respect to the AT 106a, such as the processing module 305, the inter-frequency search module 320, and the anchor carrier transition module 325 may be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. One or more of the functional blocks and/or one or more combinations of the functional blocks described with respect to the AT 106a may also be implemented as a combination of computing devices, e.g., a combination of a DSP and a microprocessor, a plurality of microprocessors, one or more microprocessors in conjunction with a DSP communication, or any other such configuration.

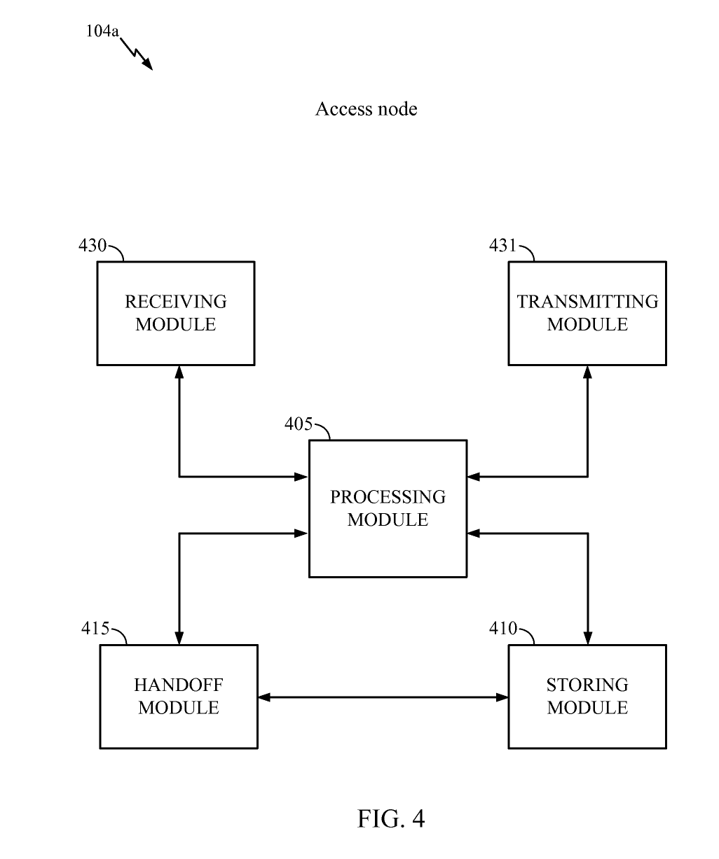

FIG. 4 is a functional block diagram of a second exemplary node 104a of FIG. 1.

As discussed above, the node 104a communicates with the AT 106a. The node 104a may comprise a receiving module 430 configured to receive an inbound message from the AT 106a and/or other devices. For example, the receiving module 430 may receive from the AT 106a a message comprising information related to a pilot signal received by the AT 106a. The node 104a may also comprise a transmitting module 431. The transmitting module 431 may send an outbound message to the AT 106a. For example, the transmitting module 431 may transmit to the AT 106a a message directing the AT 106a to handoff to another node 104. The transmitting module 431 may also send outbound messages to other devices. The receiving module 430 and the transmitting module 431 may be coupled to the processing module 405. The receiving module 430 and the transmitting module 431 may also be configured to pass an outbound message to, and receive an inbound wired message from other nodes in the communication network 100. The receiving module 430 may pass the inbound wired message to the processing module 405 for processing. The processing module 405 may process and pass the wired outbound message to the transmitting module 431 for transmission to the network 100. The processing module 405 may be configured to process the inbound and outbound wireless messages coming from or going to the AT 106a via the receiving module 430 and the transmitting module 431. The processing module 405 may also be configured to control other components of the node 104a.

The processing module 405 may further be coupled, via one or more buses, to a storing module 410. The processing module 405 may read information from or write information to the storing module 410. For example, the storing module 410 may be configured to store inbound our outbound messages before, during, or after processing. In particular, the storing module 510 may be configured to store information related to an active set for the AT 106a.

The processing module 405 may also be coupled to a handoff module 415. The handoff module 415 may be configured to direct the handoff of the AT 106a to another node 104. For example, the receiving module 430 may receive a message from the AT 106a indicating a received pilot signal and the received SNR of the pilot signal. The receiving module 430 may pass the received message to the processing module 405, which passes the message to the handoff module 415. The handoff module 415 may determine whether the SNR of the pilot signal is greater than the SNR of the nodes in the current active set stored in the storing module 410. The handoff module 415 may update the active set if the handoff module 415 determines the SNR of the pilot signal is greater than the SNR of at least one of the nodes in the current active set.

The handoff module 415 may further be configured to generate a handoff message if AT 106a moves to a cell 102 serviced by one of the nodes 104 in the active set. The message may comprise an identifier of the node 104 that services the cell 102 and the appropriate carrier frequency. The handoff module 415 may pass the message to the processing module 405 for processing. The processing module 405 may pass the message to the transmitting module 431 for transmission to the AT 106a.

The receiving module 430 and the transmitting module 431 may comprise an antenna and a transceiver. The transceiver may be configured to modulate/demodulate the wireless outbound/inbound messages going to or coming from AT 106a respectively. The wireless outbound/inbound messages may be transmitted/received via the antenna. The antenna may be configured to send and/or receive the outbound/inbound wireless messages to/from the AT 106a over one or more channels. The outbound/inbound messages may comprise voice and/or data-only information. The receiving module 430 may demodulate the data received. The transmitting module 431 may modulate data to be sent from the node 104a to the AN 106a. The processing module 405 may provide data to be transmitted.

The receiving module 430 and the transmitting module 431 may comprise a modem. The modem may be configured to modulate/demodulate the outbound/inbound wired messages going to or coming from the network 100. The receiving module 430 may demodulate data received. The demodulated data may be transmitted to the processing module 405. The transmitting module 431 may modulate data to be sent from the node 104a. The processing module 405 and/or the handoff module 415 may provide data to be transmitted.

The storing module 410 may comprise processing module cache, including a multi-level hierarchical cache in which different levels have different capacities and access speeds. The storing module 410 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, and Zip drives

Although described separately, it is to be appreciated that functional blocks described with respect to the node 104a need not be separate structural elements. For example, the processing module 405 and the storing module 410 may be embodied in a single chip. The processing module 405 may additionally, or in the alternative, contain memory, such as registers. Similarly, one or more of the functional blocks or portions of the functionality of various blocks may be embodied in a single chip. Alternatively, the functionality of a particular block may be implemented on two or more chips.

One or more of the functional blocks and/or one or more combinations of the functional blocks described with respect to the node 104a, such as the processing module 405 and the handoff module 415 may be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. One or more of the functional blocks and/or one or more combinations of the functional blocks described with respect to the node 104a may also be implemented as a combination of computing devices, e.g., a combination of a DSP and a microprocessor, a plurality of microprocessors, one or more microprocessors in conjunction with a DSP communication, or any other such configuration.

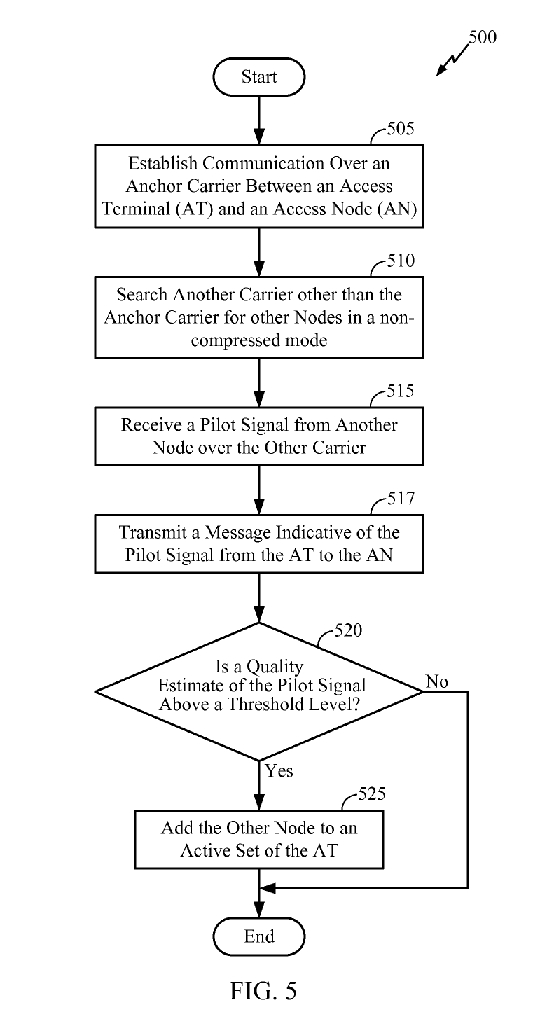

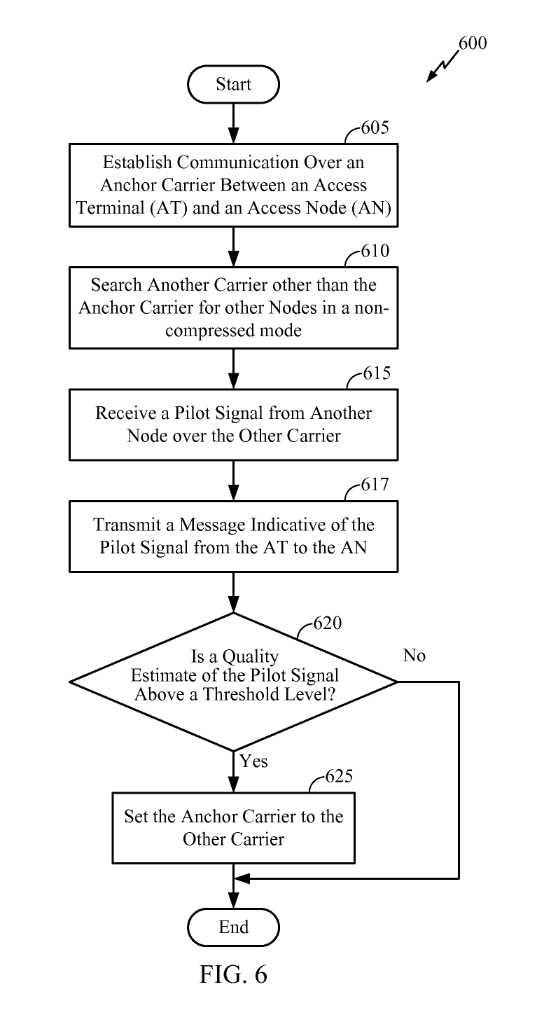

FIG. 5 is a flowchart of an exemplary process of adding access nodes on multiple carriers to an active set. At a step 505, the AT 106a establishes communication over a first carrier that is set as the anchor carrier with the node 104a. Continuing at a step 510, the AT 106a searches a second carrier that is not the anchor carrier for other nodes in a non-compressed mode. The search may be done concurrently and in parallel with the AT 106a communicating with the node 104a. Further, at a step 515, the AT 106a receives a pilot signal from another node (e.g., node 104b) over the second carrier. Next, at an optional step 517, the AT 106a transmits a message indicative of the pilot signal and the received strength of the pilot signal to the node 104a. Continuing at a step 520, the node 104a and/or the AT 106a determines whether a quality estimate (e.g., the SNR) of the pilot signal is above a threshold level. In one embodiment, the threshold level is the lowest SNR of the SNRs of the nodes in an active set of the AT 106a. If the node 104a and/or the AT 106a determine that the quality estimate is not above a threshold level. The process 500 ends. If the node 104a and/or the AT 106a determine that the quality estimate is above the threshold level, the process 500 proceeds to a step 525. At the step 525 the AT 106a and/or the node 104a adds the node 104b to the active set of the AT 106a.

FIG. 6 is a flowchart of an exemplary process of searching for access nodes on multiple carriers. At a step 605, the AT 106a establishes communication over a first carrier that is set as the anchor carrier with the node 104a. Continuing at a step 610, the AT 106a searches a second carrier that is not the anchor carrier for other nodes in a non-compressed mode. The search may be done concurrently and in parallel with the AT 106a communicating with the node 104a. Further, at a step 615, the AT 106a receives a pilot signal from another node (e.g., node 104b) over the second carrier. Next, at an optional step 617, the AT 106a transmits a message indicative of the pilot signal and the received strength of the pilot signal to the node 104a. Continuing at a step 620, the node 104a and/or the AT 106a determines whether a quality estimate (e.g., the SNR) of the pilot signal is above a threshold level. In one embodiment, the threshold level is the quality level of communications between the AT 106a and the node 104a. If the node 104a and/or the AT 106a determine that the quality estimate is not above a threshold level. The process 600 ends. If the node 104a and/or the AT 106a determine that the quality estimate is above the threshold level, the process 600 proceeds to a step 625. At the step 625 the AT 106a sets its anchor carrier to the second carrier and begins communication with the other node.

The functionality of the modules of FIGS. 2-4 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein.

The functionality described herein (e.g., with regard to one or more of the accompanying figures) may correspond in some aspects to similarly designated “means for” functionality in the appended claims. Referring to FIGS. 2-4, the node 104a and the AT 106a are represented as a series of interrelated functional modules.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP communication, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor may read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software, the functions may be stored as one or more instructions or code on a computer-readable medium. Computer-readable media includes computer storage media that facilitates transfer of a computer program from one place to another. A storage media may be any available media that can be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Further, if implemented in software, the functions may be transmitted as one or more instructions or code over a transmission medium. A transmission medium may be any available connection for transmitting the one or more instructions or code. For example, if the software is transmitted from a website, server, or other remote source using a coaxial cable, fiber optic cable, twisted pair, digital subscriber line (DSL), then the coaxial cable, fiber optic cable, twisted pair, DSL, are included in the definition of transmission medium.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A wireless communication apparatus operative in a communication network, the apparatus comprising:
a transceiver configured to communicate information over a first carrier frequency; and
a processing circuit configured to search a second carrier frequency and to evaluate a quality estimate of the second carrier frequency, wherein the transceiver is further configured to communicate over the second carrier frequency based upon the quality estimate, and wherein the processing circuit is further configured to search the second carrier frequency concurrently and in parallel with the transceiver communicating over the first carrier frequency.

2. The apparatus of claim 1, wherein the information communicated by the transceiver is communicated in a non-compressed mode.

3. The apparatus of claim 1, wherein the first carrier frequency comprises an anchor carrier.

4. The apparatus of claim 1, wherein the first carrier frequency and the second carrier frequency are not contiguous.

5. The apparatus of claim 1, wherein channel conditions of the first carrier frequency are different than channel conditions of the second carrier frequency.

6. The apparatus of claim 1, wherein the quality estimate comprises a signal to interference plus noise ratio (SINR).

7. The apparatus of claim 1, wherein the processing circuit is further configured to continuously search the second carrier frequency.

8. A wireless communication apparatus operative in a communication network, the apparatus comprising:
a transceiver configured to communicate information over at least one of a first carrier frequency and a second carrier frequency;
a memory configured to maintain an active set comprising at least a first communication device and a second communication device, wherein the wireless communication apparatus is configured to communicate with the first communication device over the first carrier frequency, wherein the wireless communication apparatus is configured to communicate with the second communication device over the second carrier frequency, and wherein the active set is a set of communication devices that serve the wireless communication apparatus; and
a processing circuit configured to search at least one of a first carrier frequency and a second carrier frequency for at least one additional communication device and to evaluate a quality estimate of a communication link with the additional communication device, and the processing circuit is further configured to add the additional communication device to the active set based upon the quality estimate, and wherein the processing circuit is further configured to search the at least one of the first carrier frequency and the second carrier frequency concurrently and in parallel with the transceiver communicating over the at least one of the first carrier frequency and the second carrier frequency.

9. The apparatus of claim 8, wherein the information communicated by the transceiver is communicated in a non-compressed mode.

10. The apparatus of claim 8, wherein at least one of the first carrier frequency and the second carrier frequency comprises an anchor carrier.

11. The apparatus of claim 8, wherein the first carrier frequency and the second carrier frequency are not contiguous.

12. The apparatus of claim 8, wherein channel conditions of the first carrier frequency are different than channel conditions of the second carrier frequency.

13. The apparatus of claim 8, wherein the quality estimate comprises a signal to interference plus noise ratio (SINR).

14. The apparatus of claim 8, wherein the processing circuit is further configured to continuously search at least one of the first carrier frequency and the second carrier frequency.

15. A method for communicating in a communication network, the method comprising:
searching a second carrier frequency concurrently and in parallel with communicating information over a first carrier frequency;
evaluating a quality estimate of the second carrier frequency; and
communicating over the second carrier frequency based upon the quality estimate.

16. The method of claim 15, further comprising communicating over the first carrier frequency in a non-compressed mode.

17. The method of claim 15, wherein the first carrier frequency comprises an anchor carrier.

18. The method of claim 15, wherein the first carrier frequency and the second carrier frequency are not contiguous.

19. The method of claim 15, wherein channel conditions of the first carrier frequency are different than channel conditions of the second carrier frequency.

20. The method of claim 15, wherein the quality estimate comprises a signal to interference plus noise ratio (SINR).

21. The method of claim 15, further comprising continuously searching the second carrier frequency.

22. A method for communicating in a communication network, the method comprising:
communicating information over at least one of a first carrier frequency and a second carrier frequency;
maintaining an active set comprising at least a first communication device and a second communication device, wherein the active set is a set of communication devices that serve a wireless communication apparatus over the first carrier frequency and the second carrier frequency, wherein the first communication device serves the wireless communication device over the first carrier frequency, and wherein the second communication device serves the wireless communication device over the second carrier frequency;
searching at least one of a first carrier frequency and a second carrier frequency for at least one additional communication device concurrently and in parallel with the transceiver communicating over the at least one of the first carrier frequency and the second carrier frequency;
evaluating a quality estimate of a communication link with the additional communication device; and
adding the additional communication device to the active set based upon the quality estimate.

23. The method of claim 22, wherein the information is communicated in a non-compressed mode.

24. The method of claim 22, wherein at least one of the first carrier frequency and the second carrier frequency comprises an anchor carrier.

25. The method of claim 22, wherein the first carrier frequency and the second carrier frequency are not contiguous.

26. The method of claim 22, wherein channel conditions of the first carrier frequency are different than channel conditions of the second carrier frequency.

27. The method of claim 22, wherein the quality estimate comprises a signal to interference plus noise ratio (SINR).

28. The method of claim 22, further comprising continuously searching at least one of the first carrier frequency and the second carrier frequency.

29. A wireless communication apparatus operative in a communication network, the apparatus comprising:
means for communicating information over a first carrier frequency; and
means for searching a second carrier frequency and to evaluate a quality estimate of the second carrier frequency, wherein the communicating means is further configured to communicate over the second carrier frequency based upon the quality estimate, and wherein the searching means is further configured to search the second carrier frequency concurrently and in parallel with the communicating means communicating over the first carrier frequency.

30. The apparatus of claim 29, wherein the information communicated by the communicating means is communicated in a non-compressed mode.

31. The apparatus of claim 29, wherein the first carrier frequency comprises an anchor carrier.

32. The apparatus of claim 29, wherein the quality estimate comprises a signal to interference plus noise ratio (SINR).

33. A wireless communication apparatus operative in a communication network, the apparatus comprising:
means for communicating information over at least one of a first carrier frequency and a second carrier frequency;
means for maintaining an active set comprising at least a first communication device and a second communication device, wherein the wireless communication apparatus is configured to communicate with the first communication device over the first carrier frequency, wherein the wireless communication apparatus is configured to communicate with the second communication device over the second carrier frequency, and wherein the active set is a set of communication devices that serve the wireless communication apparatus; and
means for searching at least one of a first carrier frequency and a second carrier frequency for at least one additional communication device and to evaluate a quality estimate of a communication link with the additional communication device, and the searching means is further configured to add the additional communication device to the active set based upon the quality estimate, and wherein the searching means is further configured to search the at least one of the first carrier frequency and the second carrier frequency concurrently and in parallel with the communicating means communicating over the at least one of the first carrier frequency and the second carrier frequency.

34. The apparatus of claim 33, wherein the information communicated by the communicating means is communicated in a non-compressed mode.

35. The apparatus of claim 33, wherein at least one of the first carrier frequency and the second carrier frequency comprises an anchor carrier.

36. The apparatus of claim 33, wherein the quality estimate comprises a signal to interference plus noise ratio (SINR).

37. A computer program product, comprising:
computer-readable medium comprising:
code for causing a computer to search a second carrier frequency concurrently and in parallel with communicating information over a first carrier frequency;
code for causing a computer to evaluate a quality estimate of the second carrier frequency; and
code for causing a computer to communicate over the second carrier frequency based upon the quality estimate.

38. The computer program product of claim 37, wherein the computer-readable medium further comprises code for causing a computer to communicate over the first carrier frequency in a non-compressed mode.

39. A computer program product, comprising:
computer-readable medium comprising:
code for causing a computer to communicate information over at least one of a first carrier frequency and a second carrier frequency;
code for causing a computer to maintain an active set comprising at least a first communication device and a second communication device, wherein the active set is a set of communication devices that serve a wireless communication apparatus over the first carrier frequency and the second carrier frequency, wherein the first communication device serves the wireless communication device over the first carrier frequency, and wherein the second communication device serves the wireless communication device over the second carrier frequency;
code for causing a computer to search at least one of a first carrier frequency and a second carrier frequency for at least one additional communication device concurrently and in parallel with the transceiver communicating over the at least one of the first carrier frequency and the second carrier frequency;
code for causing a computer to evaluate a quality estimate of a communication link with the additional communication device; and
code for causing a computer to add the additional communication device to the active set based upon the quality estimate.

40. The computer program product of claim 39, wherein the information is communicated in a non-compressed mode.
